(19) United States
(12) Patent Application Publication
(10) Pub. No.: US 2022/0019802 A1
(43) Pub. Date: Jan. 20, 2022

(54) FOOD SAFETY AND COMPLIANCE

(71) Applicant: INTERNATIONAL BUSINESS MACHINES CORPORATION, ARMONK, NY (US)

(72) Inventors: Nader M. Nassar, Yorktown Heights, NY (US); Todd D. DeLoach, Bethel, CT (US); Khwaja Jawahar Jahangir Shaik, Jacksonville, FL (US); Samuel S. Grummons, Newtown, CT (US); Annuschka Bork, New York, NY (US)

(21) Appl. No.: 16/947,047

(22) Filed: Jul. 16, 2020

(51) Int. Cl. G06K 9/00; G06K 9/62; G08B 21/02; G06Q 50/26

(52) U.S. Cl. CPC G06K 9/00718; G06K 9/6201; G06K 2009/00738; G08B 21/02; G06Q 50/265; G06K 9/00771

(57) ABSTRACT

A method comprises receiving monitoring data from at least one monitoring tool located in a food preparation area and determining from the monitoring data that a contamination event has occurred. Sending an alert to an alerting device, wherein the alert contains information about the contamination event and recording the contamination event in a log.

### BACKGROUND

The present invention relates generally to the field of food safety and compliance and more particularly to real-time monitoring of a food preparation area for compliance.

Food safety compliance in restaurants and food chains is a challenging task to monitor and enforce. Most food preparation areas can at times be full of chaos with the different people moving around and at other times can be relatively controlled environment. However, during chaotic or peaceful times contamination of the food preparation area or contamination of food items can occur. Contamination can be, for example, a cook can touch raw meat and then touch other areas without cleaning his hand or the surface he touched, or dropping utensils on the floor and then not cleaning the utensils, or if a customer ask for a certain type of preparation (i.e. vegetarian) the cooks uses the same cook surface/utensils as non-vegetarian cooking materials.

### BRIEF SUMMARY

Additional aspects and/or advantages will be set forth in part in the description which follows and, in part, will be apparent from the description, or may be learned by practice of the invention.

Embodiments of the present invention disclose a method, computer program product, and system for identifying a contamination event in a food preparation area.

A method comprises receiving monitoring data from at least one monitoring tool located in a food preparation area and determining from the monitoring data that a contamination event has occurred. Sending an alert to an alerting device, wherein the alert contains information about the contamination event and recording the contamination event in a log.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a functional block diagram illustrating a food preparations compliance environment, in accordance with an embodiment of the present invention.

FIG. 2 is a flowchart depicting operational steps of food compliance in the food preparations compliance environment of FIG. 1, in accordance with an embodiment of the present invention.

FIG. 3 is a flowchart depicting operational steps of food compliance for a special order in the food preparations compliance environment of FIG. 1, in accordance with an embodiment of the present invention.

FIG. 4 is a block diagram of components of a computing device of the secure communication systems of FIG. 1, in accordance with embodiments of the present invention.

FIG. 5 depicts a cloud computing environment according to an embodiment of the present invention.

FIG. 6 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Reference will now be made in detail to the embodiments of the present invention, examples of which are illustrated in the accompanying drawings, wherein like reference numerals refer to like elements throughout. Embodiments of the invention are generally directed to a system for food safety and compliance. The food preparation area usually includes a cook area, a preparation area, a refrigerator, freezer, cooking equipment, storage equipment, service area, and other areas where contamination events can occur. A contamination event is any type of event where contamination can occur. The contamination events can be, for example, health code violation, food utensil contamination, food storage contamination, cooking equipment contamination, service contamination, or other contamination. A health code violation can be any type of contamination that breaks the local health code. A food utensil contamination can be, for example, dropping a cooking utensil on the floor, by touching vegetarian cooking utensils to a surface touched by meat, or other utensil violations. A service contamination can be, for example, a server sneezing on the dish, the server grabbing utensil used for meat and adding them to a vegetarian dish, or other types of contamination that can be caused by people. A storage equipment contamination can be, for example, a freezer malfunction, a refrigerator malfunction, a cooking equipment malfunction, not properly cleaning any equipment, or other equipment types of contaminations or malfunctions. One type of contamination can fall under one or more categories.

Sometimes a person, such as a cook, is aware of the contamination event and can take corrective action to counteract the contamination event. However, there are times where the contamination event is not known (for example, faulty equipment), or a person who caused or witnessed the contamination event does not disclose it. In these situations, the contamination event can affect the food service, i.e. cause people to get sick, it can lead to bad reviews when a customer detects something was wrong, or other unwanted outcomes. A suite of monitoring tools can be installed in a food preparation area to monitor the area for contamination events. The suite of monitoring tools can include, for example, video cameras, temperature sensors, audio sensors, other monitoring equipment, or any combination thereof. The contamination server receives real-time data from the monitoring tools to determine when a contamination event occurs. The contamination server recognizes when a contamination event occurs and tracks the event to see if corrective action is taken to remedy the contamination event. When the contamination server detects the corrective action, then the contamination cancels the contamination event and logs the information about the event and the corrective action. If no corrective action is taken than the contamination server sends out an alert that details the contamination event, where the alert can be a message on a display, an audio alert, or a combination of both.

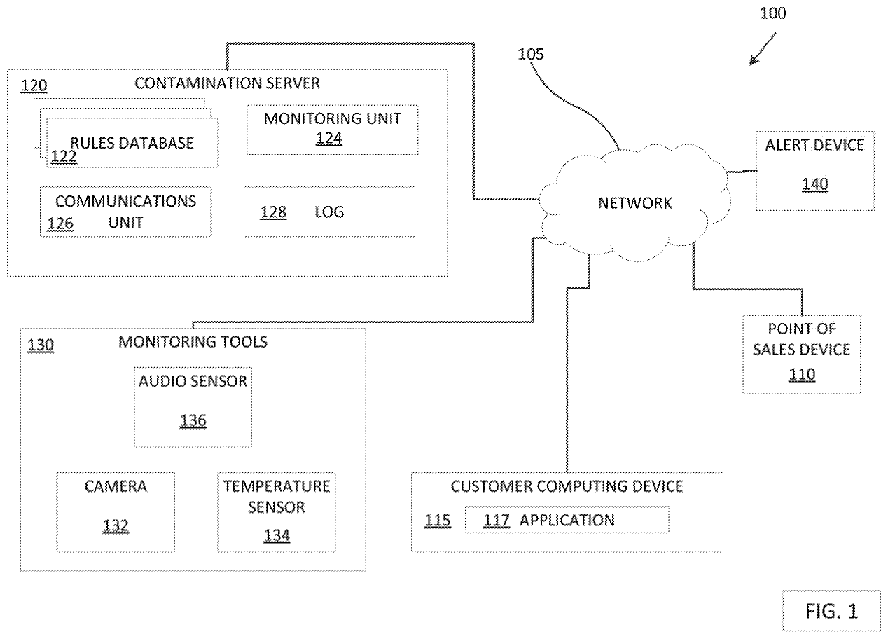

FIG. 1 is a functional block diagram illustrating a food preparations compliance environment 100, in accordance with an embodiment of the present invention.

Point of sale device 110 may be a laptop computer, tablet computer, netbook computer, personal computer (PC), a desktop computer, a personal digital assistant (PDA), a smart phone, or any programmable electronic device capable of allowing for a user to enter a food order to be transmitted to the food preparation area via the network 105. The point of sale device 110 allows the user, for example, a server, to enter a food order to be sent to the food preparation area and allows the server to enter food restrictions for the food order, i.e. vegetarian, vegan, food allergies, etc.

Customer computing device 115 may be a laptop computer, tablet computer, netbook computer, personal computer (PC), a desktop computer, a personal digital assistant (PDA), a smart phone, or any programmable electronic device capable of running application 117. The application 117 can allow for a user to enter a food order to be transmitted to the food preparation area via the network 105. The application 117 allows the user to enter food restrictions, i.e. vegetarian, vegan, food allergies, etc. to be transmitted to the food preparation area. The application 117 further allows for the user to enter comments about their food. The comments can relate to the quality of the food, the temperature of the food, missing items that were requested, items that were requested to be omitted but were added, any imperfections with the food, or comments that negatively or positively reflect the food they were served. The contamination server 120 receives the user comments and adds them to the log 128 to be reviewed to determine where the errors occurred.

Network 105 can be, for example, a local area network (LAN), a wide area network (WAN) such as the Internet, or a combination of the two, and can include wired, wireless, or fiber optic connections. In general, network 105 can be any combination of connections and protocols that will support communications between point of sales device 110, customer computing device 115, contamination server 120, monitoring tools 130 and the alert device 140.

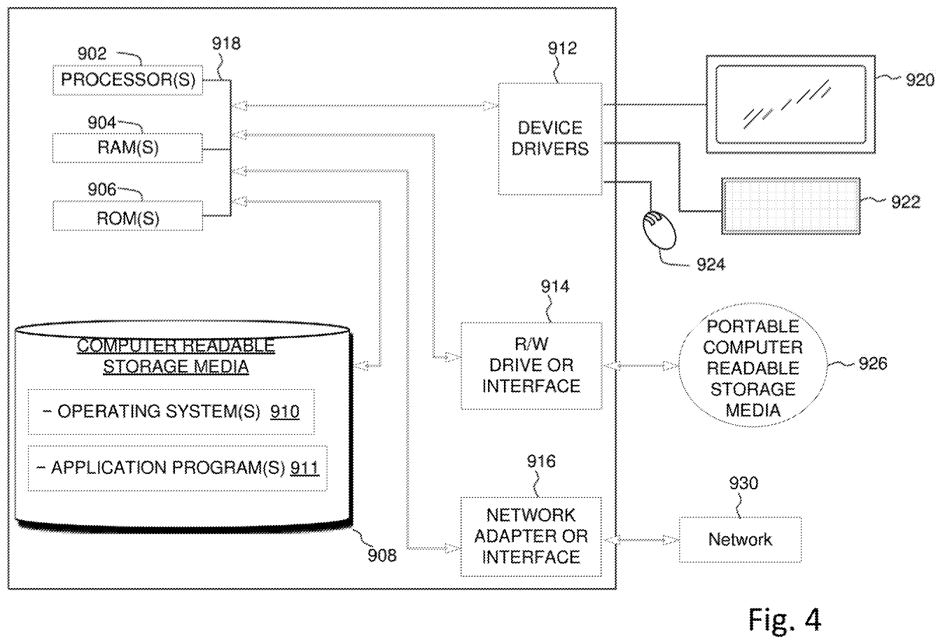

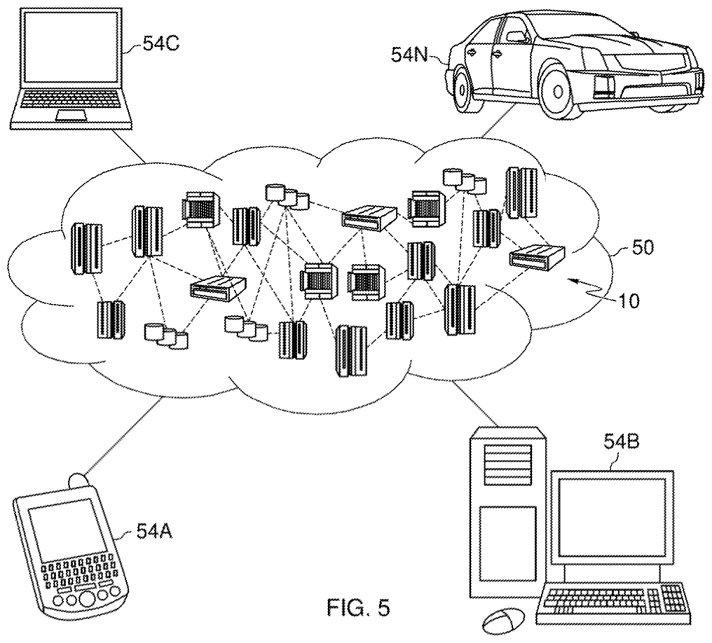

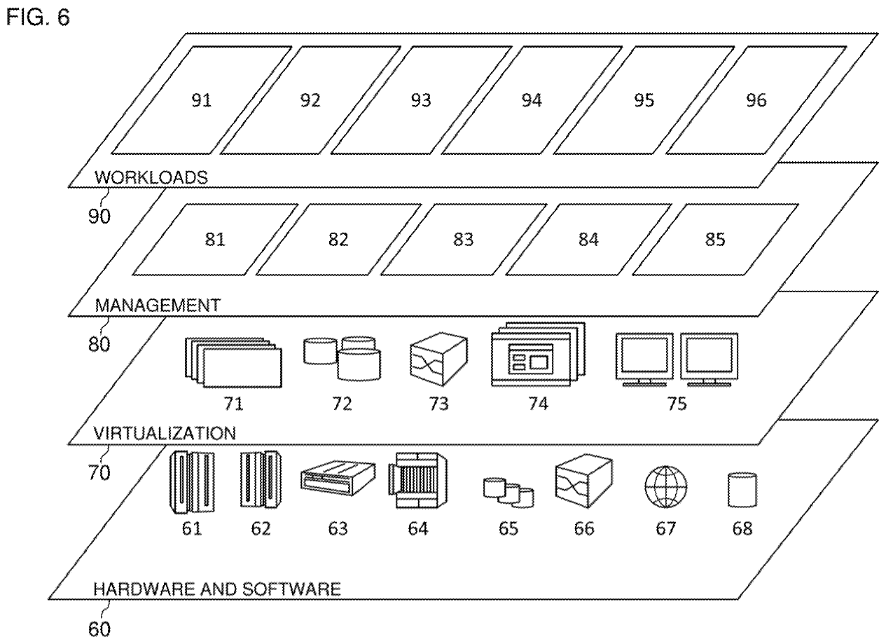

The food preparation area (not shown) contains the contamination server 120, the monitoring tools 130 and the alerting device 140. Contamination server 120 may include internal and external hardware components, as depicted, and described in further detail below with reference to FIG. 4, and operate in a cloud computing environment, as depicted in FIGS. 5 and 6.

The contamination server 120 includes rules database 122, a monitoring unit 124, a communications unit 126, and a log 128. The rules database 122 contains local health code regulations/rules, stored motion data, stored audio data, stored preference data, temperature data, and other contamination data. The local health code regulations, preference data, temperature data, and other text data relating to contamination events can be uploaded to the rules database 122 on the contamination server 120. Other data such as motion data, audio data, or other data can be taught to the contamination server. For example, the monitoring tools 130 can capture the ordinary movements, audio, and other events that occur during the normal operations of the food preparation area. During the training phase monitoring tools 130 can capture examples of contamination events and capture examples of correcting the contamination events. During the training phase the capture events that are identified as contamination events, and each captured contamination event is linked to different rule violations, for example, health code, cooking restrictions, or other rules stored in the rules database 122. Therefore, when a contamination event occurs and is identified then the monitoring unit 124 knows the corresponding rule violation. This allows for the monitoring unit 124 to display the rule violation in the alert and included the details of the contamination event and the rule violation in the entry of the event in the log 128. The rules database 122 stores the ordinary movements, audio, etc., example of contamination events, and examples of correcting the contamination events.

The monitoring tools 130 can include, for example, cameras 132, temperature sensors 134, and audio sensors 136. The cameras 132 capture movements of the people and objects in the food preparation area. The temperature sensor 134 captures the temperature of equipment (i.e. freezers, refrigerators), stored meat, vegetables, and other items. Furthermore, temperature sensor 134 can be a remote sensor that is connected to the system through a wireless connection that allows for the temperature of cooked items to be taken. The audio sensor 135 capture the audio from the food preparation area. The number of sensors can be as low as one senor, to one of each type, to a plurality of each sensor, or any combination thereof. Other sensor can capture the different areas of the food preparation area. All the capture data is transmitted via the network 105 to the contamination server 120.

The communications unit 126 receives the capture data from the monitoring tools 130. The monitoring unit 124 evaluates the receives capture data in real time to identify contamination events in the received capture data. The monitoring unit 124 analyzes the capture video data to identify the different movements of the people within the food preparation area. The monitoring unit 124 compares the identify movements to the movement stored in the rules database 122. The monitoring unit 124 classifies each movement as a normal movement, contaminating movement, or an unknown movement (a movement that has not been previously identified) or a corrective action movement. For normal movements, the monitoring unit takes no action. Contamination movements can be, for example, a person dropping cooking utensils on the floor, dropping food items on the floor, adding ingredients that were requested to be omitted to the order, not washing hands, touching raw meat and then touching other surfaces, using the wrong cooking utensils for different types of orders (i.e. vegetarian, vegan, halal, kosher, or specific allergen cookware) or other movements that might be considered contamination movements. When a contamination event occurs the monitoring unit 124 tracks the event to see if a corrective action movement occurs. A corrective action movement can be, for example, adding the dropped cooking utensils to the dishwasher, throwing out dropped food, washing hands, washing down the contaminated surfaces, starting a dish over so not to include the omitted ingredient, starting over to use the correct cook ware. When the monitoring unit 124 detects the corrective action movement, then the monitoring unit cancels the contamination event. The monitoring unit 124 transmits every identified contamination event and corrective action movement to the log 128. The log 128 is a data store that stores every identified contamination event, corrective action movement, and alert that is identified and issued by the contamination server 120. When a corrective action movement is not detected, then the communications unit 126 transmits an alert to the alerting device 140. The alert can be an audio alert, a visual alert, or a combination thereof. The alert indicates that the contamination event occurred and what the contamination event was. The alerting device 140 can be any type of display or wearable device that can be connected to the contamination server 120 via the network 105. Furthermore, the monitoring unit 124 transmits the contamination event and the alert to the log 128 to be recorded. When an unknown event is triggered, i.e. when the monitoring tools captures a movement that has not been previously identified, then the monitoring unit 124 triggers a contamination event. The communications unit 126 transmits an alert the alerting device to indicate that an unknown event has occurred. The alerting device 140 can allow a user, for example, a cook, a server, a manager, or somebody else to identify the unknown event. Once the unknown event has been identified, then the monitoring unit 124 transmits now identified event, to the log 128 and stores the now identified event in the appropriate location in rules database 122.

The monitoring unit 124 further receives temperature data from the temperature sensor 134. The temperature sensors 134 can be mounted in freezers, refrigerators, a meat preparation station, a handheld wireless thermometer, or another temperature sensor. The temperature sensors 134 send the temperature data back to the monitoring unit. The monitoring unit 124 compares the received temperature data from the temperature sensors 134 to the temperature data stored in rules database 122. When the monitoring unit determines that the received temperature data is out of allowed range, then the monitoring unit 124 triggers a contamination event. The communications unit 126 transmits an alert to the alerting device 140. The alert can be an audio alert, a visual alert, or a combination thereof. The alert indicates that the contamination event occurred and what the contamination event was. When the contamination event corresponds to temperature data from a handheld wireless thermometer, the monitoring unit 124 monitors the incoming data in real time to determine if the temperature data from the handheld wireless thermometer indicates that the contamination event has been corrected. For example, the handheld wireless thermometer is utilized to take the temperature of cooking meat to see if the meat is up to the correct temperature. If the meat is not the correct temperature a contamination event is triggered by the monitoring unit 124. When the monitoring unit 124 receives another temperature reading from the thermometer and the monitoring unit determines that temperature reading corresponds to the same meat item in the contamination event, and the temperature reading is within an allowed range, then a contamination event has been corrected. When the meat is served and a corrected temperature is not detected, then the monitoring unit 124 triggers an alert about the contamination event occurring. Furthermore, the monitoring unit 124 transmits the contamination event and the alert to the log 128 to be recorded.

Audio sensor 136 detects audio communications between people within the food preparation area. The detected audio communications can include conversations between people in the food area, where the conversation can contain reference to a contamination event. For example, the conversation includes the phrase “expiration date”, “spoilage”, or something similar, which would indicate that contamination event should be triggered . . . The audio sensors 136 will detect the verbal communications and transmit them to the contamination server 120 via the network 105. The monitoring unit 124 receives the audio data and analyzes the audio data for phrases that indicate a contamination event. The monitoring unit 124 compares received audio to audio data stored in the rules database 122 to determine if a contamination event occurs. Alternatively, the monitoring unit 124 can convert the audio data into a text document and analyze the text document to determine if a contamination event occurs. When a monitoring unit detects a contamination event, then the communications unit 126 transmits an alert the alerting device 140. The alert can be an audio alert, a visual alert, or a combination thereof. The alert indicates that the contamination event occurred and what the contamination event was. The alerting device 140 can be any type of display or wearable device that can be connected to the contamination server 120 via the network 105. Furthermore, the monitoring unit 124 transmits the contamination event and the alert to the log 128 to be recorded.

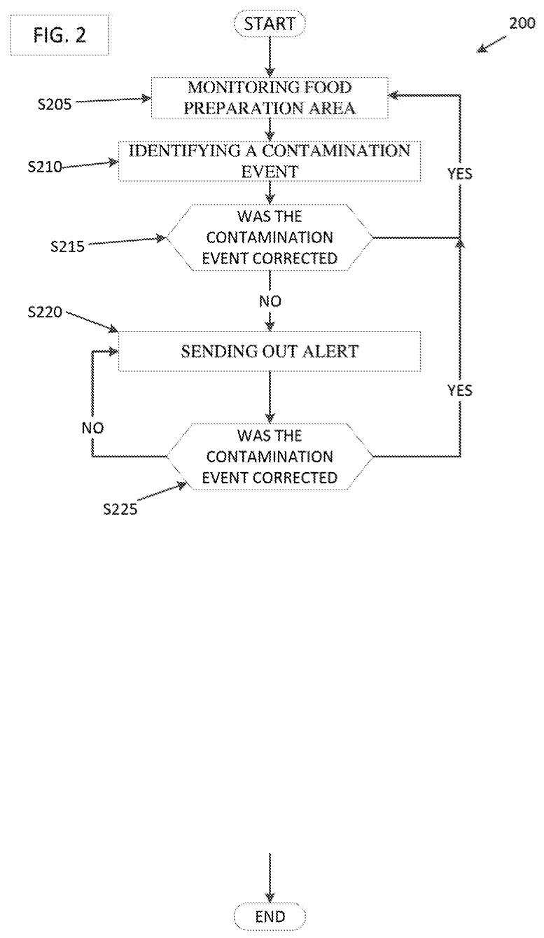

FIG. 2 is a flowchart depicting operational steps of food compliance in the food preparations compliance environment 100 of FIG. 1, in accordance with an embodiment of the present invention.

The monitoring tools 130 collect data on the food preparation area in real-time. The monitoring tools 130 can include cameras 132, temperature sensors 134, audio sensors 136, and/or other sensor to collect data on the food preparation area. The real-time data collected by the monitoring tools 130 is sent to the contamination server 120 to be analyzed (S205). The monitoring tools 130 are constantly collecting data and transmitting it to the contamination server 120 in real time. The monitoring unit 124 analyzes the data collected by the monitoring tools 130 to determine if a contamination event occurs (S210). The monitoring unit 124 compares the collected data to data stored in the rules database 122 to identify a contamination event in the collected data. The data stored in the rules database 122 contains previously identified contamination events and the corresponding health code violations, using meat cooking utensils for a vegetarian dish, items stored at the wrong temperature, items served at the wrong temperature, unknown movements (i.e. movements not previously identified), or other violations that are linked to the contamination event. Therefore, by matching the events in the collected data to the event data stored in the rules database 122, then the contamination event and the corresponding rule it violates can be identified (S210). When a contamination event has been detected, the monitoring unit 124 analyzes the incoming data from the monitoring tools to determine if a corrective action has occurred (S215). The corrective action can be washing a dropped pan, throwing out dropped food, starting a dish over again, fixing a unit to store items at correct temperature, etc. When the monitoring unit 124 determines that a corrective action has occurred, then the monitoring unit 124 cancels the contamination event and logs the contamination event and correct action in the log 128 (S215). The monitoring unit 124 then continues to monitor for new contamination events. When the monitor unit 124 does not detect a corrective action, then the monitoring unit sends out an alert to the alerting device (S220). The alert can be an audio alert, a visual alert, or a combination thereof. The alert indicates that the contamination event occurred and what the contamination event was. For the situation where the contamination event was an unknown movement, then the alert contains a request for the contamination event to be identified. The monitoring unit 124 analyzes the incoming data from the monitoring tools to determine if a corrective action has occurred after the alert was sent (S225). When the corrective action has not be taken then the alert is transmitted again (S220). When the monitoring unit 124 determines that a corrective action has occurred, then the monitoring unit 124 cancels the contamination event and logs the contamination event and correct action in the log 128 (S220). The monitoring unit 124 then continues to monitor for new contamination events.

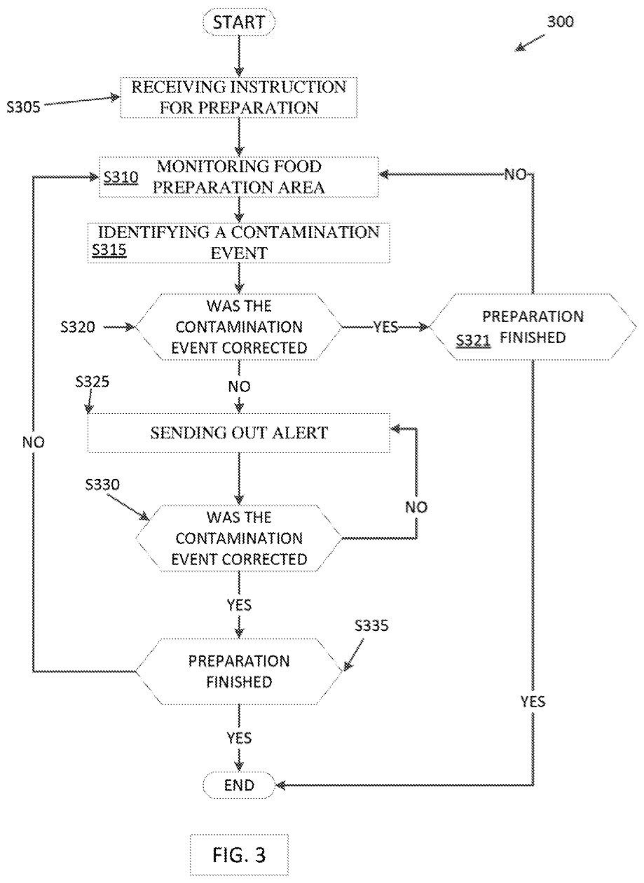

FIG. 3 is a flowchart depicting operational steps of food compliance for a special order in the food preparations compliance environment 100 of FIG. 1, in accordance with an embodiment of the present invention.

A server can enter special instruction for the preparation for an item in a point of sale device 110 or a user can enter the special instructions into an application 114 when they order an item. The food preparation area receives the food order with the special instructions and the contamination server 120 receives the special instructions (S305). The special instructions can be asking for items to be omitted from the food order, indicating a food allergy, indicating a preparation preference, a type of dish (i.e. vegetarian, vegan, kosher, halal, etc.), or different type of instructions. The monitoring tools 130 are collecting data on the food preparation area for the preparation of the food item with the special instructions. The monitoring tools 130 can include cameras 132, temperature sensors 134, audio sensors 136, and/or other sensor to collect data on the food preparation area. The data collected by the monitoring tools 130 is sent to the contamination server 120 to be analyzed to see if a contamination event occurs (S310). The monitoring tools 130 are constantly collecting data and transmitting it to the contamination server 120 in real time. The monitoring unit 124 analyzed the data collected by the monitoring tools 130 to see if a contamination event occurs (S315). The monitoring unit 124 compares the collected data to information stored in the rules database 122 to identify a contamination event. The data stored in the rules database 122 contains previously identified contamination events and the corresponding rules violations linked to the identified contamination event. The linked rules violations can be, for example, health code violations, using meat cooking utensils for a vegetarian dish, items stored at the wrong temperature, items served at the wrong temperature, unknown movements (i.e. movements not previously identified), or other violations. Therefore, by matching the events in the collected data to the data stored in the rules database 122, then the contamination event and the corresponding rule it violates can be identified (S315). When a contamination event has been detected, the monitoring unit 124 analyzes the incoming data from the monitoring tools to determine if a corrective action has occurred (S320). The corrective action can be washing a dropped pan, throwing out dropped food, starting a dish over again, fixing a unit to store items at correct temperature, etc. When the monitoring unit 124 determines that a corrective action has occurred, then the monitoring unit 124 cancels the contamination event and logs the contamination event and correct action in the log 128 (S320). The monitoring unit 124 determines if the preparation of the food order is done (S321), if the preparation of the food item has not been completed, then the monitoring unit 124 continues to monitor for new contamination events. When the monitoring unit determines the preparation of the food item is complete, then the monitoring unit stop monitoring for contamination events that corresponds with the preparation of the food order with special instructions.

When the monitoring unit 124 does not detect a corrective action at step S320, then the monitoring unit sends out an alert to the alerting device 140 (S325). The alert can be an audio alert, a visual alert, or a combination thereof. The alert indicates that the contamination event occurred and what the contamination event was. The monitoring unit 124 analyzes the incoming data from the monitoring tools to determine if a corrective action has occurred after the alert was sent (S330). When a person within the food preparation area has not performed a corrective action for the contamination event, then the monitoring unit 124 resends the alert again to the alerting device 140 (S325). When the monitoring unit 124 determines that a corrective action has occurred, then the monitoring unit 124 cancels the contamination event and logs the contamination event and correct action in the log 128 (S330). The monitoring unit 124 determines if the preparation of the food order has been completed (S335), if the preparation of the food order has not been completed then the monitoring unit 124 continues to monitor for new contamination events. When the monitoring unit determines the preparation of the food item is complete, then the monitoring unit stop monitoring for that item.

FIG. 4 depicts a block diagram of components of the contamination server 120, the customer computing device 115, or the point of sales device 110 of the food preparations compliance environment 100 of FIG. 1, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

The contamination server 120, the customer computing device 115, or the point of sales device 110 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. The network adapter 916 communicates with a network 930. Communications fabric 918 may be implemented with any architecture designed for passing data and/or control information between processors (such as microprocessors, communications, and network processors, etc.), system memory, peripheral devices, and any other hardware components within a system.

One or more operating systems 910, and one or more application programs 911, for example, monitoring unit 124 (FIG. 1), are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The contamination server 120, the customer computing device 115, or the point of sales device 110 may also include a R/W drive or interface 914 to read from and write to one or more portable computer readable storage media 926. Application programs 911 the contamination server 120, the customer computing device 115, or the point of sales device 110 may be stored on one or more of the portable computer readable storage media 926, read via the respective R/W drive or interface 914 and loaded into the respective computer readable storage media 908.

The contamination server 120, the customer computing device 115, or the point of sales device 110 may also include a network adapter or interface 916, such as a Transmission Control Protocol (TCP)/Internet Protocol (IP) adapter card or wireless communication adapter (such as a 4G wireless communication adapter using Orthogonal Frequency Division Multiple Access (OFDMA) technology). Application programs 911 on the contamination server 120, the customer computing device 115, or the point of sales device 110 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

The contamination server 120, the customer computing device 115, or the point of sales device 110 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and food contamination determination unit 96.

Based on the foregoing, a computer system, method, and computer program product have been disclosed. However, numerous modifications and substitutions can be made without deviating from the scope of the present invention. Therefore, the present invention has been disclosed by way of example and not limitation.

While the invention has been shown and described with reference to certain exemplary embodiments thereof, it will be understood by those skilled in the art that various changes in form and details may be made therein without departing from the spirit and scope of the present invention as defined by the appended claims and their equivalents.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

What is claimed is:

1. A method comprising:
receiving, by a computer, monitoring data from at least one monitoring tool located in a food preparation area;
determining, by the computer, from the monitoring data that a contamination event has occurred;
sending, by the computer, an alert to an alerting device, wherein the alert contains information about the contamination event; and
recording, by the computer, the contamination event in a log.

2. The method of claim 1, wherein the monitoring data includes at least video data.

3. The method of claim 2, wherein the determining, by the computer, from the monitoring data that the contamination event has occurred comprises:
comparing, by the computer, the video data to video data stored in a database to see if any of the actions in the video data match previously identified actions that correspond to contamination events.

4. The method of claim 1, further comprising:
receiving, by the computer, new monitoring data from at least one monitoring tool located in a food preparation area; and
determining, by the computer, from the new monitoring data that a corrective action event has occurred, wherein the corrective action corrects the identified contamination event.

5. The method of claim 4, wherein the monitoring data includes at least video data.

6. The method of claim 5, wherein the determining, by the computer, from the monitoring data that the contamination event has occurred comprises:
comparing, by the computer, the video data to video data stored in a database to see if any of the actions in the video data match previously identified actions that correspond to contamination events.

7. The method of claim 6, wherein the new monitoring data includes at least new video data and wherein the determining, by the computer, from the new monitoring data that a corrective action event has occurred comprises comparing, by the computer, the at least new video data to video data stored in the database to see if any of the actions in the new video data match previously identified corrective actions that correspond to contamination events.

8. The method of claim 7, wherein recording, by the computer, the contamination event in the log further includes recording the corrective action.

9. A computer program product comprising:
one or more non-transitory computer-readable storage media and program instructions stored on the one or more non-transitory computer-readable storage media, the program instructions comprising:
program instructions to receive monitoring data from at least one monitoring tool located in a food preparation area;
program instructions to determine from the monitoring data that a contamination event has occurred;
program instructions to send, an alert to an alerting device, wherein the alert contains information about the contamination event; and
program instructions to record the contamination event in a log.

10. The computer program product of claim 9, wherein the monitoring data includes at least video data.

11. The computer program product of claim 10, wherein the program instructions to determine from the monitoring data that the contamination event has occurred comprises:
program instruction to compare the video data to video data stored in a database to see if any of the actions in the video data match previously identified actions that correspond to contamination events.

12. The computer program product of claim 9, further comprising:
program instructions to receive new monitoring data from at least one monitoring tool located in a food preparation area; and
program instructions to determine from the new monitoring data that a corrective action event has occurred, wherein the corrective action corrects the identified contamination event.

13. The computer program product of claim 12, wherein the monitoring data includes at least video data.

14. The computer program product of claim 13, wherein the program instructions to determine from the monitoring data that the contamination event has occurred comprises:
program instructions to compare the video data to video data stored in a database to see if any of the actions in the video data match previously identified actions that correspond to contamination events.

15. The computer program product of claim 6, wherein the new monitoring data includes at least new video data and wherein the program instruction to determine from the new monitoring data that a corrective action event has occurred comprises program instruction to compare the at least new video data to video data stored in the database to see if any of the actions in the new video data match previously identified corrective actions that correspond to contamination events.

16. The computer program product of claim 7, wherein the program instruction to record the contamination event in the log further includes recording the corrective action.

17. A computer system comprising:
one or more computer processors, one or more computer-readable storage media, and program instructions stored on one or more of the computer-readable storage media for execution by at least one of the one or more processors, the program instructions comprising:
program instructions to receive monitoring data from at least one monitoring tool located in a food preparation area;
program instructions to determine from the monitoring data that a contamination event has occurred;
program instructions to send, an alert to an alerting device, wherein the alert contains information about the contamination event; and
program instructions to record the contamination event in a log.

18. The computer system of claim 17, wherein the monitoring data includes at least video data.

19. The computer system of claim 18, wherein the program instructions to determine from the monitoring data that the contamination event has occurred comprises:
program instruction to compare the video data to video data stored in a database to see if any of the actions in the video data match previously identified actions that correspond to contamination events.

20. The computer system of claim 19, further comprising:
program instructions to receive new monitoring data from at least one monitoring tool located in a food preparation area; and
program instructions to determine from the new monitoring data that a corrective action event has occurred, wherein the corrective action corrects the identified contamination event:
wherein the monitoring data includes at least video data;
wherein the program instructions to determine from the monitoring data that a contamination event has occurred comprises program instructions to compare the video data to video data stored in a database to see if any of the actions in the video data match previously identified actions that correspond to contamination events; and
wherein the new monitoring data includes at least new video data and wherein the program instruction to determine from the new monitoring data that a corrective action event has occurred comprises program instruction to compare the at least new video data to video data stored in the database to see if any of the actions in the new video data match previously identified corrective actions that correspond to contamination events.
